(19) United States
(12) Patent Application Publication
(10) Pub. No.: US 2006/0285621 A1
(43) Pub. Date: Dec. 21, 2006

(54) Method and device for initiating a fusion reaction through isomer potentiated nuclear decay

(76) Inventor: Marlin Brandt Pohlman, Tulsa, OK (US)

Correspondence Address: STITES & HARBISON PLLC, 1199 NORTH FAIRFAX STREET, SUITE 900, ALEXANDRIA, VA, 22314, US

(21) Appl. No.: 11/140,909

(22) Filed: Jun. 1, 2005

(51) Int. Cl. G21G 1/06

(52) U.S. Cl. 376/158

(57) ABSTRACT

A method and device for initiating a fusion reaction through isomer potentiated nuclear decay, wherein a fissionable casing is initially provided. A high-energy density material is located in the casing, and a radiation source is provided for irradiating the high-energy density material to cause the high-energy density material to decay and produce a photonic gas. The photonic gas is directed onto a fusion tamper located in the casing, causing the fusion tamper to collapse. Finally, a fusion fuel located in the casing adjacent the fusion tamper is fused in response to heat and pressure produced by the collapsing of the fusion tamper, resulting in a release of thermonuclear energy. Preferably, the high-energy density material is a high-spin isomer having MeV excitation energies and a long lifetime and is selected from the group consisting of Ta-180, Os-178, Yt-186, Z-66n, Hf-174, Hf-175,Hf-176, Hf-177 and Hf-178.

### FIELD OF THE INVENTION

The present invention relates to the use of high-spin isomers that are distinguished by the combination of MeV isotopes excitation energies and long lifetimes such as Ta-180, Os-178, Yt-186, Z-66n, Hf-174, Hf-175, Hf-176, Hf-177 and Hf-178, hereafter referred to as high-energy density materials (HEDM's) to initiate a fusion explosion through the production of a 2.445 MeV-2.685 MeV photon gas within a depleted uranium container to cause imploding of a lithium-6 deuteride/lithium-6 tritide deuteride structure.

### THEORETICAL BASIS OF THE INVENTION

An isomeric state usually has a single particle configuration that is significantly different from that of the ground state and is often characterized by high values of the spin and spin projection quantum numbers I and K. The decay of such an isomer to the ground-state band is retarded by the electromagnetic selection rules for the change of I, K, and parity. Therefore, the excitation or depletion of an isomeric state in a nuclear reaction can be expected to be reduced by the spin difference in accordance with the statistical model and by structure selectivity.

As a result of the spin difference, isomer HEDMs have potential energy yields orders of magnitude greater than existing chemical energetics and the fact this energy is released as a 2.445-2.685 MeV photon discharge lends itself to the use of Ta-180, Os-178, Yt-186, Z-66n, Hf-174, Hf-175, Hf-176, Hf-177 and Hf-178 in place of a fissile core.

The triggering of induced gamma emission from isomer HEDMs presents an intense source of short-wavelength radiation. An example of this is the 16+4-qp isomer of Hf-178 which stores 2.445 MeV for a half-life of 31 years meaning that as a material, such isomeric Hf-178 would store 1.3 GJ/g (10 kg per gram of material) which will be released as a photon gas when irradiated with X-ray pulses derived from a device operated at 15 mA to produce bremsstrahlung radiation with end point energies set to values between 60 and 90 keV. Such an accelerated decay of the Hf-178 isomer is consistent with an integrated cross section of 2.2×10.22 cm² keV if the resonant absorption of the X-rays takes place below 20 keV as indicated by the use of selective absorbing filters in the irradiating beam.

Fusion is then accomplished by the physical pressure and heat generated by the x-ray's and other gamma radiation moving outward from the HEDM trigger at 3×10⁸ m/s.

### SUMMARY OF THE INVENTION

A release of energy can come only from an atom or nucleus that is in an ‘excited’ state with its pairs of spinning electrons, neutrons or protons storing trapped energy. When putting energy into an electron, by firing in x-rays, one can flip over the spin so that the spin is parallel to its partner's, which is not immediately reversible. This spring lock is usually triggered immediately in the case of atoms, which return to a relaxed state by radiating away light or x-rays within milliseconds. But the nucleus is a different environment. By ‘flipping’ the direction in which protons spin, the internal geometry of the nucleus is changed, creating a form called an “isomer”. Paired spin states of protons carry great amounts of energy and can last indefinitely. Isomers such as Ta-180 and Hf-178 may then be triggered by x-rays from a bremsstrahlung radiation source within a controlled environment composed of U-238 to compress a combination of lithium-6 tritide, deuteride and lithium-deuteride, initiating a fusion-fission reaction.

Other features and advantages of the present invention are stated in or apparent from detailed descriptions of presently preferred embodiments of the invention found hereinbelow.

### BRIEF DESCRIPTION OF THE DRAWINGS

FIG. 1 is a schematic illustration of a fusion-fission reaction device in accordance with the present invention.

FIG. 2 is a schematic illustration of the device in FIG. 1 where the HEDM is subjected to high energy radiation, resulting in decay and a photonic gas.

FIG. 3 is a schematic illustration of the reflection of the photonic gas onto a fusion tamper.

FIG. 4 is a schematic illustration of the initiation of fusion of a tritiated portion and the inner fusion fuel.

FIG. 5 is a schematic illustration of the resultant fission of the reflector shield.

### DETAILED DESCRIPTION OF THE INVENTION

With reference now to the drawings in which like numerals represent like elements throughout the views, a thermonuclear device 10 is depicted. Broadly, device 10 includes a single compressed unit of HEDM material 12 that makes up the primary ignition system. Upon irradiation the HEDM 12 material begins decay of the HEDM isomer to the ground-state. The weapon casing 18 reflects radiation pressure around the thick radiation shield 20 and onto the sides of the fusion tamper 22 collapsing the tamper 22 inward. Heat and pressure of the impact start fusion of the tritiated portion 24 of the fusion fuel pencil. The precise location of the tritium 24 within the pencil depends on where the designer intends the fusion reaction to begin. Neutrons from this fusion activity breed tritium throughout the pencil. Fusion fuel 26 reacts virtually simultaneously throughout the pencil releasing 130 kilotons of energy to complete the second stage. High-energy neutrons from fusion are absorbed by the Uranium-238 outer shell 18 which has so far served as a radiation shield and reflector turning the reflector 18 into fission fuel. The U-238 therein thus fissions, adding another 130 kilotons of energy to the explosion.

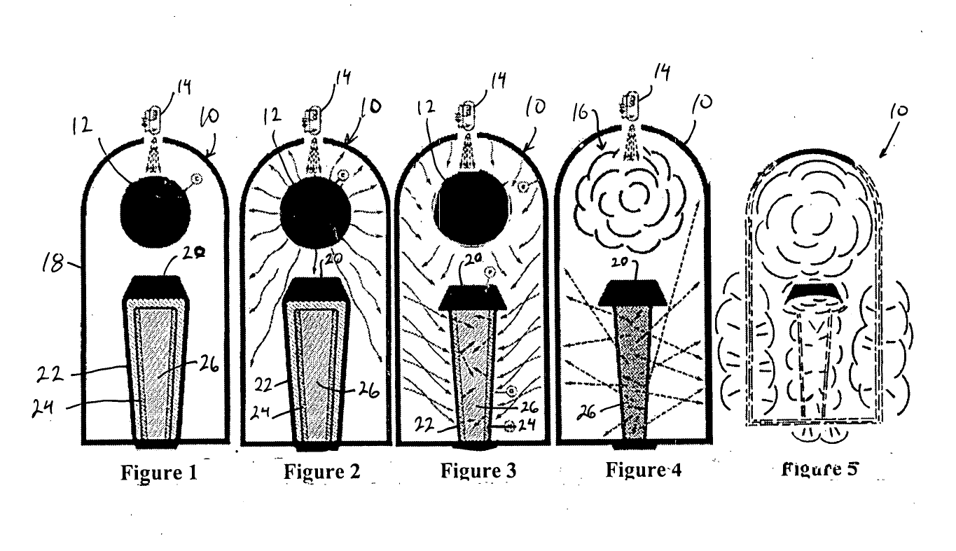

Depicted in FIG. 1 is a 270 kiloton isomer potentiated thermonuclear device 10 in accordance with the present invention. This device 10 has a casing 18 inside which is contained sufficient compressed high-energy density material 12 to produce a ten kiloton explosive force. As indicated above, material 12 is a high-energy density material selected from the group of Ta-180, Os-178, Yt-186, Z-66n, Hf-174, Hf-175, Hf-176, Hf-177 & Hf-178 and any other material which will produce the effects as noted below. Device 10 also includes a radiation source 14 operated at 15 mA to produce bremsstrahlung radiation with end point energies set to values between 60 and 90 keV as known in the art.

In FIG. 2, the high-energy density material 12 is shown as being subjected to x-rays from radiation source 14 with end point energies set to values between 60 and 90 keV. This radiation results in decay of the HEDM isomer material 12 to the ground-state, and the consequent production of a photonic gas or pressure 16 with ten kilotons of explosive force in casing 18.

With reference to FIG. 3, it will be appreciated that weapon casing 18 includes a reflector and secondary fission fuel. Thus, casing 18 reflects the produced radiation pressure around the thick U-238 radiation shield 20 and hence onto the sides of a fusion tamper 22 such as lithium-6 deuteride. This causes the fusion tamper 22 to collapse inward.

Consequently, as shown in FIG. 4, the heat and pressure of the impact then initiates fusion of the tritiated portion 24 (such as lithium-6 tritide deuteride) and of an inner fusion fuel “pencil” 26 composed of lithium-6 deuteride. Neutrons from this fusion activity breed tritium throughout the pencil 26, so that this fusion fuel reacts virtually simultaneously throughout the pencil 26 releasing 130 kilotons of energy to complete the second stage of device 10.

Finally, as shown in FIG. 5, high-energy neutrons from the fusion of pencil 26 are absorbed by the U-238 outer radiation shield 20, which previously has served as a radiation shield and reflector. These neutrons thus turn cause the reflector shield 20 to fission, with the U-238 fissions thus adding another 130 kilotons of energy to the explosion.

While the present invention has been described with respect to an exemplary embodiment thereof, it will be understood by those of ordinary skill in the art that variations and modifications can be effected within the scope and spirit of the invention.

I claim:

1. A thermonuclear device comprising:
a fissionable casing;
a high-energy density material located in said casing;
a radiation source which causes said high-energy density material to decay and produce a photonic gas;
a fusion tamper located in said casing which is collapsed by the photonic gas; and
a fusion fuel in said casing and adjacent said fusion tamper which fuses in response to heat and pressure produced by the collapsing of said fusion tamper.

2. A thermonuclear device as claimed in claim 1, wherein said high-energy density material is a high-spin isomer having MeV excitation energies and a long lifetime.

3. A thermonuclear device as claimed in claim 2, wherein said high-energy density material is selected from the group consisting of Ta-180, Os-178, Yt-186, Z-66n, Hf-174, Hf-175, Hf-176, Hf-177 and Hf-178.

4. A thermonuclear device as claimed in claim 1, wherein said casing includes U-238 which fissions in response to neutron radiation produced by the fusing of said fusion fuel.

5. A thermonuclear device as claimed in claim 1, wherein said fusion fuel includes an outer tritrided and deutrided cover and an inner deutrided portion.

6. A thermonuclear device as claimed in claim 1, wherein said casing is elongated with said high-energy density material at one end and said fusion fuel at the other, and further including a radiation shield between said fusion fuel and said high-energy density material.

7. A thermonuclear device as claimed in claim 2, wherein said casing includes U-238 which fissions in response to neutron radiation produced by the fusing of said fusion fuel.

8. A thermonuclear device as claimed in claim 7, wherein said fusion fuel includes an outer tritrided and deutrided cover and an inner deutrided portion.

9. A thermonuclear device as claimed in claim 8:
wherein said casing is elongated with said high-energy density material at one end and said fusion fuel at the other, and
further including a radiation shield between said fusion fuel and said high-energy density material.

10. A method for releasing thermonuclear energy comprising the steps of:
providing a fissionable casing;
locating a high-energy density material in the casing;
irradiating the high-energy density material with a radiation source, said irradiating step causing the high-energy density material to decay and produce a photonic gas;
directing the photonic gas onto a fusion tamper located in the casing, said directing step causing the fusion tamper to collapse; and
fusing a fusion fuel located in the casing adjacent the fusion tamper in response to heat and pressure produced by said collapsing step, said fusing step resulting in a release of thermonuclear energy.

11. A method for releasing thermonuclear energy as claimed in claim 10, wherein the high-energy density material is a high-spin isomer having MeV excitation energies and a long lifetime.

12. A method for releasing thermonuclear energy as claimed in claim 11, wherein the high-energy density material is selected from the group consisting of Ta-180, Os-i 78, Yt-186, Z-66n, Hf-174, Hf-175, Hf-176, Hf-177 and Hf-178.

13. A method for releasing thermonuclear energy as claimed in claim 10, wherein said providing step includes providing of the casing with U-238 which fissions in response to neutron radiation produced by the fusing of said fusion fuel.

14. A method for releasing thermonuclear energy as claimed in claim 10, wherein fusing step includes the providing of the fusion fuel with an outer tritrided and deutrided cover and an inner deutrided portion.

15. A method for releasing thermonuclear energy as claimed in claim 10:
wherein said providing step provides the casing as an elongated casing with the high-energy density material located at one end and the fusion fuel at the other; and
further including the step of locating a radiation shield between the fusion fuel and the high-energy density material.

16. A method for releasing thermonuclear energy as claimed in claim 11, wherein said providing step includes providing of the casing with U-238 which fissions in response to neutron radiation produced by the fusing of said fusion fuel.

17. A method for releasing thermonuclear energy as claimed in claim 16, wherein fusing step includes the providing of the fusion fuel with an outer tritrided and deutrided cover and an inner deutrided portion.

18. A method for releasing thermonuclear energy as claimed in claim 17:
wherein said providing step provides the casing as an elongated casing with the high-energy density material located at one end and the fusion fuel at the other; and
further including the step of locating a radiation shield between the fusion fuel and the high-energy density material.
